(19) United States
(12) Patent Application Publication
(10) Pub. No.: US 2024/0335789 A1
(43) Pub. Date: Oct. 10, 2024

(54) EMULSION-TYPE DEHUMIDIFYING COMPOSITION FOR REMOVING MOISTURE AND METHOD FOR PRODUCING THE SAME

(71) Applicant: KOREA UNIVERSITY RESEARCH AND BUSINESS FOUNDATION, Seoul (KR)

(72) Inventors: Yong Tae KANG, Seoul (KR); Jae Won LEE, Seoul (KR); Minjae KIM, Gwacheon-si Gyeonggi-do (KR); Hyung Won CHOI, Bucheon-si Gyeonggi-do (KR)

(21) Appl. No.: 18/579,218

(22) PCT Filed: Apr. 20, 2022
(86) PCT No.: PCT/KR2022/005653

§ 371 Date: Jan. 12, 2024

(30) Foreign Application Priority Data
Jul. 15, 2021 (KR) 10-2021-0092804

(51) Int. Cl. B01D 53/28; B01D 53/26

(52) U.S. Cl. CPC B01D 53/28; B01D 53/263; B01D 2252/20; B01D 2257/80; B01D 2258/06

(57) ABSTRACT

A dehumidifying composition according to an embodiment of the present invention includes oil and a surfactant, wherein the oil and the surfactant may be mixed by at least one of mechanical stirring, ultrasonic stirring, ultrasonic grinding, or magnetic stirring.

### TECHNICAL FIELD

The present disclosure relates to a dehumidifying composition for removing moisture from an industrial process or indoors.

### BACKGROUND ART

With a recent development of modern industry, diversification and marketability of various products are becoming more important. In packaging for production, storage, distribution, and sale of the product, consumer demands for convenience of handling, quality preservation, and the like are gradually increasing.

In particular, in a case of food or an electronic product that is sensitive to moisture, it is necessary to keep the inside of the packaging dry. This is because the moisture is an important cause of deteriorating a quality of the packaged product by changing physical properties of the product, causing rancidity and a nutritional loss, and inducing oxidation corrosion on a metal surface.

In addition, the moisture from various industrial processes or indoors needs to be removed.

A dehumidifier is used to remove the moisture in various fields.

Korean Patent No. 2067217 discloses a biodegradable polymer customized dehumidifying resin composition containing porous zeolite.

### DETAILED DESCRIPTION OF THE INVENTION

### Technical Problem

The present disclosure is to provide an emulsion-type dehumidifying composition for removing moisture from an industrial process or indoors.

### Technical Solution

A dehumidifying composition contains oil and a surfactant.

A method for producing a dehumidifying composition includes producing of adding a surfactant to oil and stirring the surfactant.

A method for producing a dehumidifying composition includes adding 60 g of Tween 80 to each 400 g of silicone oil and stirring the Tween 80, and additionally adding 120 g of Span 80 to each 400 g of the silicone oil and stirring the Span 80 when the stirring of the Tween 80 in the silicone oil is completed.

### Advantageous Effects of the Invention

The dehumidifying composition in the present disclosure may capture the moisture in the form of droplets via the surfactant contained in the oil. The oil containing the plurality of droplets may take the form of the emulsion.

The droplet surrounded by the surfactant may grow beyond the set size because of the continuous influx of the moisture.

The dehumidifying composition in the present disclosure may provide the new type of dehumidification function of trapping the moisture inside the oil rather than absorbing the moisture. The moisture trapped in the wall formed by the surfactant may destroy the corresponding wall and be collected at the top or bottom of the oil via the increase in the size of the droplet or low-temperature heat.

Therefore, in the recycling process of the dehumidifying composition, various types of energy provided to the heat source used for the moisture discharge may be saved.

In addition, the dehumidifying composition in the present disclosure has significantly smaller corrosiveness compared to the existing dehumidifying agent with high corrosiveness. Therefore, a metal-based heat exchanger that is vulnerable to corrosion but has high thermal conductivity may be disposed around the dehumidifying composition. As a result, a heat exchange efficiency applied in the recycling process of the dehumidifying composition may be greatly increased, low-temperature regeneration of the dehumidifying composition (below 80° C.) may become available, and low-temperature unused energy, such as the solar heat and the waste heat, may be used.

### DESCRIPTION OF THE DRAWINGS

FIG. 1 is a schematic diagram showing a moisture capture process of a dehumidifying composition in the present disclosure.

FIG. 2 is a graph showing a moisture capture performance based on a surfactant addition concentration.

FIG. 3 is a schematic diagram showing an evaluation device to check a moisture capture performance of a dehumidifying composition.

FIG. 4 is a photograph of a dehumidifying composition in the present disclosure.

FIG. 5 is a photograph of a dehumidifying composition in the present disclosure for which a moisture capture evaluation has been completed.

FIG. 6 is a flowchart showing a method for producing a dehumidifying composition in the present disclosure.

### BEST MODE

Hereinafter, with reference to the attached drawings, embodiments of the present disclosure will be described in detail to be easily implemented by those skilled in the art in the technical field to which the present disclosure belongs. However, the present disclosure may be implemented in several different forms and may not be limited to the embodiments described herein. To clearly illustrate the present disclosure in the drawings, parts unrelated to the description were omitted, and similar reference numbers were assigned to similar parts throughout the present document.

Herein, duplicate descriptions of the same components are omitted.

In addition, herein, when a first component is mentioned as being ‘connected’ to a second component, it should be understood that the first component may be directly connected to the second component, but there may be a component interposed therebetween. On the other hand, herein, when it is mentioned that the first component is ‘directly connected’ to the second component, it should be understood that there are no other components interposed therebetween.

In addition, the terms used herein are merely used to describe specific embodiments and are not intended to limit the present disclosure.

In addition, herein, the singular expression includes the plural expression unless the context clearly dictates otherwise.

In addition, herein, it should be understood that terms such as “include” or “have” are intended to specify that a feature, a number, a step, an operation, a component, a part, or a combination thereof described herein is present, and do not preclude a possibility of addition or existence of one or more other features or numbers, steps, operations, components, parts, or combinations thereof.

In addition, herein, the term ‘and/or’ includes a combination of a plurality of listed items or any item among the plurality of listed items. Herein, ‘A or B’ may include ‘A’, ‘B’, or ‘both A and B’.

In addition, herein, detailed descriptions of known functions and configurations that may obscure the gist of the present disclosure will be omitted.

Existing moisture removal methods include 1) condensing and removing moisture by lowering a temperature of incoming air to a temperature equal to or lower than a dew point temperature using an evaporator in a vapor compression cycle system, 2) adsorbing and removing the moisture using a solid hygroscopic material, or 3) absorbing and removing the moisture using a liquid hygroscopic material.

The vapor compression cycle system is not suitable as a dehumidification technology because a purpose thereof is temperature control and humidity control is a secondary effect, and the hygroscopic material is used in conjunction with building air conditioning equipment.

Each of a liquid dehumidifying agent and a solid dehumidifying agent has advantages and disadvantages, and is selected depending on an application environment. However, both require a regeneration process to recycle the dehumidifying agents for long-term use.

To release captured moisture from a dehumidifying material, a representative method is to increase the temperature, and an electric heater is mainly used. In the long term, the air conditioning equipment with a combined dehumidification function has a problem of requiring energy consumption caused by use of an electric heat source for the regeneration.

As the existing liquid dehumidifying agent, aqueous solution based on molten salt with excellent hygroscopic properties, such as LiCl, CaCl₂), and LiBr, is used. The existing liquid dehumidifying agents are commonly highly corrosive, making it difficult to directly use a material with high thermal conductivity, such as carbon steel and copper. The existing liquid dehumidifying agents use a scheme such as coating treatment for preventing surface corrosion, addition of a corrosion inhibitor, or use of stainless steel, but such scheme is becoming a factor that increases a production cost. Additionally, the existing liquid dehumidifying agent requires heating at a temperature equal to or higher than 100° C. in a process of vaporizing captured water for recycling. While an energy independence rate of the building is being emphasized by carbon neutrality policies, heating energy consumption for the regeneration of the dehumidifying agent may act as a disadvantage. In a case of the solid dehumidifying agent, various microstructure-based materials (MOF; Metal Organic Framework, COF; Covalent Organic Framework, and the like) are being developed in a field of materials research, but in a case of the liquid dehumidifying agent, there is a design limitation of the material itself. As a solution to such problem, there is research on ionic liquid, but it is still difficult to enter the market because of a high price thereof, so that a new concept of the liquid dehumidifying agent material is needed.

A dehumidifying composition 100 in the present disclosure may include oil and a surfactant. Specifically, the dehumidifying composition 100 may be produced using only two ingredients: the oil and the surfactant.

The dehumidifying composition 100 may take a form of the surfactant dispersed in the liquid oil.

The oil and the surfactant may be mixed with each other by at least one of mechanical stirring, ultrasonic stirring, ultrasonic grinding, and magnetic stirring.

The surfactant may create moisture droplets within the oil by surrounding and trapping moisture introduced from the outside. An emulsion in which the moisture trapped by the surfactant is spread throughout the oil may be formed.

The oil may include at least one of mineral oil, synthetic oil, silicone oil, and vegetable oil.

The mineral oil may include at least one of Paraffinic oil, Naphenic oil, and Aromatic oil.

The synthetic oil may include at least one of polyalphaolefin, polyglycol, and synthetic ester oil.

The vegetable oil may include at least one of soybean oil, sunflower oil, grape seed oil, coconut oil, and olive oil.

The surfactant may include at least one of an anionic surfactant, a cationic surfactant, an amphoteric ion surfactant, and a non-ionic surfactant.

The anionic surfactant may include at least one of alkylbenzene sulfonate, ammonium lauryl sulfate, chlorosulfolipid, docusate, perfluorobutanesulfonic acid, potassium lauryl sulfate, soap, sodium alkyl sulfate, sodium dodecyl sulfate, sodium laurate, sodium laureth sulfate, sodium nonanoyl oxybenzene sulfonate, and sulfolipid.

The cationic surfactant may include at least one of behentrimonium chloride, benzalkonium chloride, benzododecinium bromide, cetalkonium chloride, cetrimonium bromide, cetylpyridinium chloride, dimethyldioctadecylammonium bromide, dimethyldioctadecylammonium chloride domiphen bromide, octenidine dihydrochloride, olaflur, pahutoxin, and stearalkonium chloride.

The amphoteric ion surfactant may include at least one of lauryl betaine, sodium hydroxymethylglycinate, RENNIN, and cocamidopropyl betaine.

The non-ionic surfactant may include at least one of alkyl polyglycoside, cetyl alcohol, glycerol monostearate, gum arabic, nonoxynol, oleyl alcohol, polysorbate, poly vinyl alcohol, sorbitan, sorbitan monolaurate, sorbitan monostearate, sorbitan monooleate (Span 80), Triton X-100, and Tween 80.

The dehumidifying composition 100 in the present disclosure, which corresponds to the surfactant mixture, may increase dispersibility by surrounding the moisture droplets.

The surfactant may include at least one selected from a group consisting of the anionic surfactant, the cationic surfactant, the non-ionic surfactant, and the amphoteric ion surfactant. Such division is based on a type of hydrophilic group. The anionic surfactant refers to a surfactant in which a long chain atomic group (hydrophobic part) becomes an anion and include soap, phosphate ester, sulfate, sulfonate, and the like. The cationic surfactant refers to a surfactant whose long chain becomes a cation and includes quaternary ammonium salt, amine salt, pyridine salt, and the like. The non-ionic surfactant refers to a surfactant that does not have a charged group and includes polyethylene glycol, polyhydric alcohol, fatty acid ethylene oxide, and the like. The amphoteric surfactant refers to a surfactant that has both the cation and the anion within a molecule, is controlled by pH, and includes an amino acid type, a betaine type, and the like.

A hydrophilic lipophilic balance (HLB) is a numerical representation of degrees of hydrophilicity and lipophilicity of the surfactant. The HLB starts with 1, starting from the most lipophilic. A widely used surfactant usually has the HLB between 1 and 20. Specifically, a HLB value of the surfactant mixture may be obtained by Mathematical Formula 1.

$$[ Mathematical Formula 1 ]$$

$${HLB}_{surfactant mixture} = \frac{( {W}_{A} \times {HLB}_{A} ) + ( ( {W}_{B} \times {HLB}_{B} )}{( {W}_{A} + {W}_{B} )}$$

Here, WA and WB are weight fractions of the respective surfactants mixed with each other.

An added mass of the oil may affect a moisture capture performance, and an amount (a concentration) of the oil added may be determined based on a required performance.

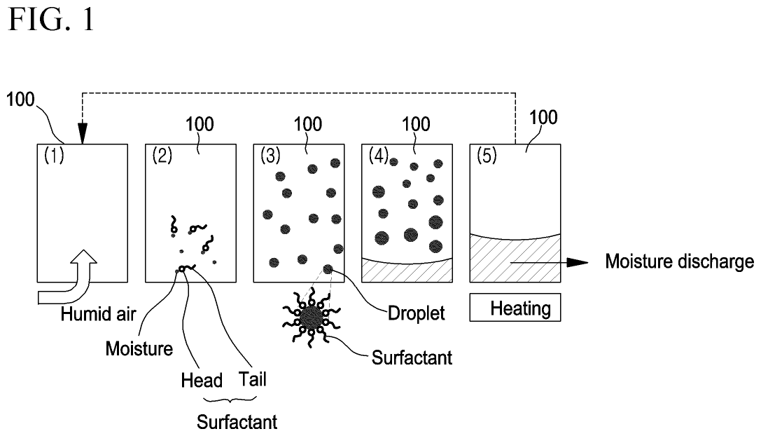

FIG. 1 is a schematic diagram showing a moisture capture process of the dehumidifying composition 100 in the present disclosure.

A first stage 1, a second stage 2, a third stage 3, a fourth stage 4, a fifth stage 5, and a sixth stage 6 are disclosed.

In the first stage 1, humid air, which is air with the moisture, may be introduced into the dehumidifying composition 100 containing the oil and the surfactant.

In the second stage 2, the moisture in a vapor state may be trapped in the form of droplets by the condensation or combination with the surfactant when coming into contact with the liquid dehumidifying composition 100.

In the third stage 3, the moisture in the humid air exists uniformly in the dehumidifying composition 100 in the form of droplets, resulting in the emulsion state in which the moisture is spread throughout the oil.

The surfactant is a substance with two different properties that allows water and oil to be mixed with each other. In the case of surfactant, a long chain of nonpolar carbon atoms constitutes a hydrophobic portion, and a polar hydrophilic portion is significantly smaller than the hydrophobic portion, so that the hydrophilic portion is referred to as a head and the long hydrophobic chain is referred to as a tail. When the moisture flows into the dehumidifying composition 100, the head of the surfactant faces the moisture droplet and the tail faces the oil, as shown in FIG. 1. Because of numerous surfactant components surrounding the moisture, a wall to trap the moisture may be formed and the fine moisture may grow into larger droplets.

In the fourth stage 4, the droplets may grow because of continuous moisture supply. Because of the growth of the moisture droplets or coupling of the moisture droplets, an emulsion formation limit may be reached and the dispersion of the droplets may be destroyed.

When the dehumidifying composition 100 is heated for the regeneration in the fifth stage 5, the oil and the moisture may be separated from each other because of the temperature. The silicone oil or the like has a lower density than water, so that the moisture is collected at the bottom. When oil with a higher density than water is used, a vertical relationship may change.

The moisture may be discharged and only the oil may return to the first stage 1 via the sixth stage 6. When the heating is not necessary, the fifth stage 5 may be excluded, and the sixth stage 6 may proceed directly from the fourth stage 4. The third stage 3 and the fourth stage 4 were written sequentially to increase understanding of the capture principle, and may actually occur simultaneously.

The dehumidifying composition 100 in the present disclosure is composed of the oil and the surfactant and thus is chemically stable and non-corrosive, so that a peripheral system (dehumidification and heat exchange) with high thermal conductivity like copper may be built. Additionally, according to the present disclosure, a material cost may be reduced because the system does not need to be constructed with stainless steel or plastic to prevent the corrosion. In addition, according to the present disclosure, the moisture regeneration is easy as the temperature rises, so that regeneration operation may be achieved at lower temperatures compared to an existing liquid dehumidifying agent system.

Accordingly, the regeneration operation may be achieved with solar heat or waste heat, resulting in significant energy savings.

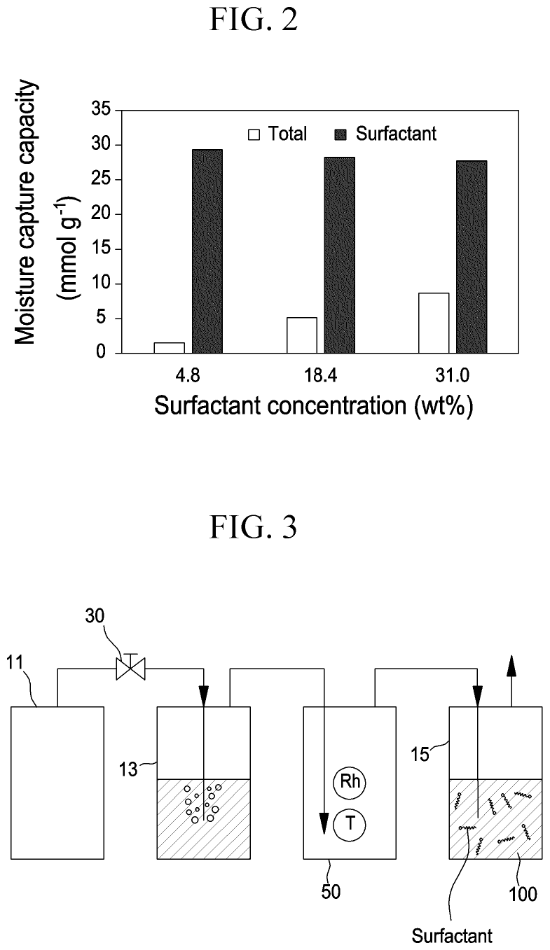

FIG. 2 is a graph showing a moisture capture performance based on a surfactant addition concentration.

The surfactant may be mixed with the oil in an added amount that is twice or more than a set moisture capture amount within a range that satisfies a concentration from 4.8 wt % to 31.0 wt % with respect to the oil.

Moisture capture capacities ‘a’ and ‘B’ are shown in Mathematical Formula 2.

$$α = \frac{Moisture capture amount}{Total mass ( oil + surfactant )} \qquad [ Mathematical Formula 2 ]$$

$$β = \frac{Moisture capture amount}{Surfactant mass}$$

‘α’ is expressed as ‘Total’ in FIG. 2, and is a result of applying a mass of the dehumidifying agent (including both the oil and the surfactant) to a denominator in Mathematical Formula 2.

‘β’ is expressed as ‘Surfactant’ in FIG. 2, and is a result of applying only a mass of the surfactant to a denominator in Mathematical Formula 2.

According to ‘α’, the moisture capture capacity improved as the added amount of the surfactant increased. For example, in an experiment in which the Tween 80 and the Span 80 were added to the silicone oil at a mass ratio of 2:3, when the surfactant (in a combined amount of the Tween 80 and the Span 80) was added at 4.8 wt % to the silicone oil, a performance of 1.72 mmolg-′ was obtained, and when 13.4 wt % of the surfactant was added, a performance of 5.31 mmolg-1 was obtained. When 31.0 wt % of the surfactant was added, a performance of 8.57 mmolg-1 was obtained.

According to ‘β’, it may be seen that dividing the moisture capture amount by the surfactant added amount yields a constant value.

When analyzing ‘α’ and ‘β’ above, it may be seen that the surfactant is a main cause or mechanism of the moisture capture.

The moisture capture performance of 8.57 mmol g⁻¹ at 31.0 wt % shows that the moisture may be captured at half the added amount of the surfactant, and the capture performance of the dehumidifying composition 100 may be controlled by the added amount of the surfactant. The added amount of the surfactant may be determined within a range from 1.5 to 2.5 times the moisture capture amount.

As shown in the example above, the plurality of types of surfactants may be mixed in the oil. In this case, the plurality of types of surfactants may be sequentially added to the oil and stirred in an ascending order of the addition concentration. For example, a first surfactant and a second surfactant of different types may be mixed in the oil. In this regard, one of the first surfactant and the second surfactant with a smaller addition concentration may be added to the oil, and after the mixing with the oil is completed, the other with a greater addition concentration among the first surfactant and the second surfactant may be added to the oil and mixed with the oil. When 60 g of the Tween 80 is added and 120 g of the Span 80 is added, the Tween 80 with a smaller addition concentration and a smaller added amount (a mass) may be added to the oil first. After a stirring operation to disperse the Tween 80 into the oil is completed, the Span 80 may be added to and stirred into the oil.

It was found that as the concentration of the surfactant increases, an efficiency decreases slightly. When the surfactants are evenly mixed in a nonpolar solvent such as the oil and a concentration at which the surfactants may meet each other is reached, reverse micelles in which the surfactants agglomerate within the oil are created. The capture performance, which slightly decreases as the concentration increases, is presumed to be resulted from the reverse micelles.

FIG. 3 is a schematic diagram showing an evaluation device to check the moisture capture performance of the dehumidifying composition 100.

The evaluation device may include a gas tank 11, a flow rate adjustor 30, a water tank 13, a measurer 50, and a dehumidifying tank 15.

N₂ gas may be stored in the gas tank 11. The gas tank 11 may be connected to the water tank 13 via the flow rate adjustor.

The flow rate adjustor 30 may adjust an amount of the N₂ gas flowing from the gas tank 11 to the water tank 13.

Water may be stored in the water tank 13. A pipe extending below a water level may be disposed inside the water tank 13. When one end of the corresponding pipe is immersed in water, the other end of the corresponding pipe may be connected to an input end of the water tank 13 into which the N₂ gas flows.

The N₂ gas introduced from the gas tank 11 may be output into water via the corresponding pipe. The N₂ gas output from the distal end of the pipe may contain the moisture while rising in a form of bubbles inside water, and the N₂ gas containing the moisture may flow into the dehumidifying tank 15 via the measurer 50.

The measurer 50 may be equipped with a thermometer T that measures a temperature of the N₂ gas and a hygrometer Rh that measures a humidity of the N₂ gas. The flow rate adjustor 30 may be controlled based on the measurement results of the measurer. The flow rate adjustor 30 may be feedback-controlled via the measurer and may adjust a flow rate of the N₂ such that the N₂ gas flowing into the dehumidifying tank 15 satisfies a set temperature and a set humidity.

The dehumidifying composition 100, which captures the moisture contained in the N₂ gas introduced from the water tank 13, may be stored in the dehumidifying tank 15. The dehumidifying tank 15 may operate at a humidity of 40±5% and a temperature of 25±1° C. The moisture capture amount was measured via masses before and after a test (before: ‘mi’ and after: ‘m_{f}’) of the dehumidifying composition 100 based on Mathematical Formula 3, and a capture performance ‘α’ was represented by dividing the capture amount by a mass md of the dehumidifying composition 100, in units of mmolg−1, as shown in Mathematical Formula 4.

$$Q ( g ) = {m}_{f} ( g ) - {m}_{i} ( g ) \qquad [ Mathematical Formula 3 ]$$

$$[ Mathematical Formula 4 ]$$

$$α ( {mmolg}^{- 1} ) = \frac{Q ( g )}{{m}_{d} ( g )} / water molecular weight ( g / mol ) * 1000$$

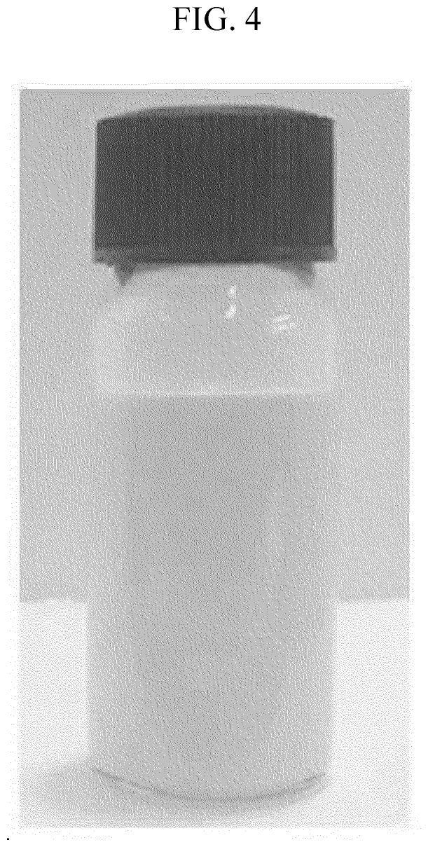

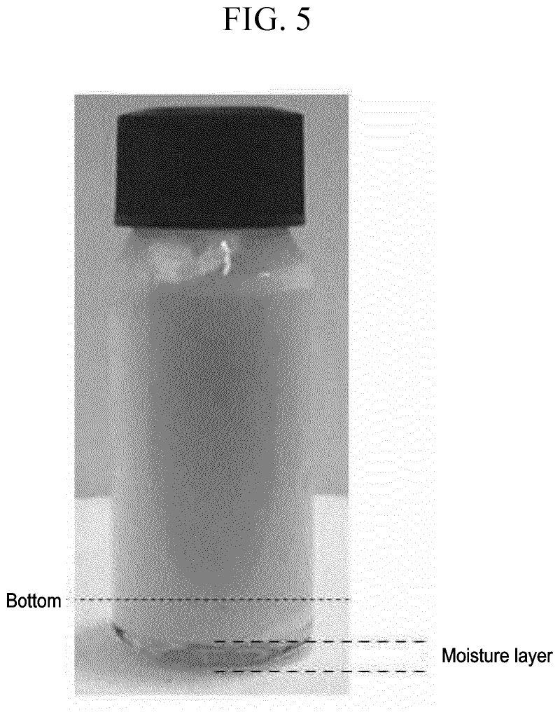

FIG. 4 is a photograph of the dehumidifying composition 100 in the present disclosure, and FIG. 5 is a photograph of the dehumidifying composition 100 in the present disclosure for which the moisture capture evaluation has been completed.

The photograph in FIG. 4 shows the dehumidifying composition 100 filled in a vial. It may be seen that the dehumidifying composition 100 appears cloudy as the surfactants are spread.

The moisture capture evaluation in FIG. 5 may be conducted on an experiment (a surfactant addition concentration of 31 wt %) in which 60 g of the Tween 80 and 120 g of the Span 80 were added for each 400 g of the silicone oil.

FIG. 5 shows a state when the dehumidifying composition 100 that has completed the moisture capture evaluation, was exposed to 60° C. It may be seen that the dispersibility of the moisture droplets was not maintained, resulting in layer separation caused by a moisture layer captured at the bottom. The separated moisture layer may facilitate the regeneration of the dehumidifying composition 100 and the separation of the moisture.

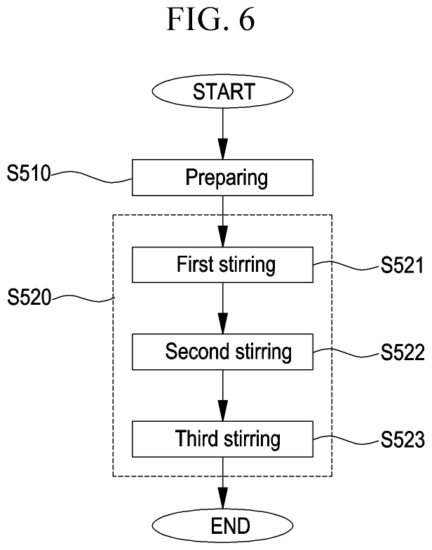

FIG. 6 is a flowchart showing a method for producing the dehumidifying composition 100 in the present disclosure.

Preparing (S510) in which the oil and the surfactant are prepared may be performed.

When the preparing (S510) is completed, producing (S520) of adding the surfactant to the oil and stirring the surfactant may be performed.

In the producing (S520), the surfactant may be mixed into the oil in the amount that is twice or more than the set moisture capture amount within the range that satisfies the concentration from 4.8 wt % to 31.0 wt % with respect to the oil.

The producing (S520) may include a first step (S521) and a second step (S522).

In the first step (S521), the first surfactant with the small addition concentration among the plurality of types of surfactants may be added to the oil and stirred in the oil.

The second step (S522) may be performed when the addition and the stirring of the first surfactant with respect to the oil are completed. In other words, the second step (S522) may be performed after completion of the first step (S521).

In the second step (S522), the second surfactant with the greater addition concentration than the first surfactant among the plurality of types of surfactants may be added to the oil and stirred in the oil.

When the types of surfactants added to the oil increase, a third step (S523) or the like in which a third surfactant is added and stirred may be added accordingly.

When the plurality of types of surfactants are added, an addition concentration or an added amount of each surfactant may be determined based on HLB-based calculation results. When the addition concentrations are determined, the surfactants may be sequentially added to and stirred in the oil in the ascending order of the addition concentration. When the surfactants are added to and stirred in the oil in a descending order of the addition concentration, the surfactant with the small concentration added later may not be well dispersed in the oil because of the high-concentration surfactant already added.

In addition, when the plurality of types of surfactants are added at once, the agglomeration such as the reverse micelles where the surfactants mix with each other first may occur. Therefore, it is better to add another type of surfactant after completing addition and stirring of one type of surfactant.

In the process of mixing the first surfactant, no separate dispersion process other than the stirring is required. However, the dispersion of the second surfactant, the third surfactant, and the like may be suppressed by other surfactants already added. Therefore, in the process after the second step (S522), an additional mixing process using an ultrasonic grinder is required. During the producing process, a temperature range from 10 to 40° C. may be maintained to exclude temperature effects. Finally, the emulsion-type dehumidifying composition 100, which is the mixture of the oil and the surfactants, may be completed.

As an example, 60 g of the Tween 80 may be added to and stirred in each 400 g of the silicone oil via the first step (S521). A total addition concentration of surfactants may be set at 31 wt % (when there is 400 g of the silicone oil, Tween80: 60 g, Span80: 120 g, and the addition ratio of the two surfactants 1:2). A stirring speed may be 120 rpm and a stirring time may be 30 minutes.

When the stirring of the Tween 80 in the silicone oil is completed, 120 g of the Span 80 may be additionally added for each 400 g of the silicone oil via the second step (S522), followed by the stirring and the ultrasonic grinding. A stirring speed may be 120 rpm and a stirring time may be 30 minutes. The ultrasonic grinding may be performed simultaneously with the stirring, and specifications of the ultrasonic grinder that performs the ultrasonic grinding may be 20 Hz and 500 W. As production capacity increases, the stirring time may be proportionally increased. During the producing process, a temperature was maintained at 25° C. using a double-jacketed beaker, and accordingly, the silicone oil-based emulsion-type dehumidifying composition 100 was able to be completed.

Although the embodiment of the present disclosure has been described in detail above, the scope of rights of the present disclosure is not limited thereto, and various forms of modification and improvement by those skilled in the art using the basic concept of the present disclosure defined in the following claims also fall within the scope of rights of the present disclosure.

1. A dehumidifying composition containing oil and a surfactant.

2. The dehumidifying composition of claim 1, wherein the dehumidifying composition has a form with the surfactant dispersed in the liquid oil.

3. The dehumidifying composition of claim 1, wherein the oil and the surfactant are mixed with each other via at least one of mechanical stirring, ultrasonic stirring, ultrasonic grinding, and magnetic stirring.

4. The dehumidifying composition of claim 1, wherein the surfactant surrounds and traps moisture introduced from the outside to create droplets of the moisture within the oil,
wherein an emulsion where the moisture trapped by the surfactant spreads throughout the oil is formed.

5. The dehumidifying composition of claim 1, wherein the oil includes at least one of mineral oil, synthetic oil, silicone oil, and vegetable oil,
wherein the mineral oil includes at least one of Paraffinic oil, Naphenic oil, and Aromatic oil,
wherein the synthetic oil includes at least one of polyalphaolefin, polyglycol, and synthetic ester oil,
wherein the vegetable oil includes at least one of soybean oil, sunflower oil, grape seed oil, coconut oil, and olive oil,
wherein the surfactant includes at least one of an anionic surfactant, a cationic surfactant, an amphoteric ion surfactant, and a non-ionic surfactant,
wherein the anionic surfactant includes at least one of alkylbenzene sulfonate, ammonium lauryl sulfate, chlorosulfolipid, docusate, perfluorobutanesulfonic acid, potassium lauryl sulfate, soap, sodium alkyl sulfate, sodium dodecyl sulfate, sodium laurate, sodium laureth sulfate, sodium nonanoyl oxybenzene sulfonate, and sulfolipid,
wherein the cationic surfactant includes at least one of behentrimonium chloride, benzalkonium chloride, benzododecinium bromide, cetalkonium chloride, cetrimonium bromide, cetylpyridinium chloride, dimethyldioctadecylammonium bromide, dimethyldioctadecylammonium chloride domiphen bromide, octenidine dihydrochloride, olaflur, pahutoxin, and stearalkonium chloride,
wherein the amphoteric ion surfactant includes at least one of lauryl betaine, sodium hydroxymethylglycinate, RENNIN, and cocamidopropyl betaine,
wherein the non-ionic surfactant includes at least one of alkyl polyglycoside, cetyl alcohol, glycerol monostearate, gum arabic, nonoxynol, oleyl alcohol, polysorbate, poly vinyl alcohol, sorbitan, sorbitan monolaurate, sorbitan monostearate, sorbitan monooleate (Span 80), Triton X-100, and Tween 80.

6. The dehumidifying composition of claim 1, wherein an added amount of the surfactant is determined within a range from 1.5 to 2.5 times a moisture capture amount.

7. The dehumidifying composition of claim 1, wherein a plurality of types of surfactants are mixed with the oil,
wherein the plurality of types of surfactants are sequentially added to and stirred in the oil in an ascending order of an addition concentration.

8. The dehumidifying composition of claim 1, wherein a first surfactant and a second surfactant of different types are mixed in the oil,
wherein, among the first surfactant and the second surfactant, one with a smaller addition concentration is added to the oil and then completely mixed with the oil, and then the other with a greater addition concentration among the first surfactant and the second surfactant is added to and mixed with the oil.

9. The dehumidifying composition of claim 1, wherein the surfactant is mixed with the oil in an added amount twice or more than a set moisture capture amount within a range satisfying a concentration from 4.8 wt % to 31.0 wt % with respect to the oil.

10. A method for producing a dehumidifying composition, the method comprising:
producing of adding a surfactant to oil and stirring the surfactant.

11. The method of claim 10, wherein the producing includes mixing the surfactant with the oil in an added amount twice or more than a set moisture capture amount within a range satisfying a concentration from 4.8 wt % to 31.0 wt % with respect to the oil.

12. The method of claim 10, wherein the producing includes a first step and a second step,
wherein the first step includes adding a first surfactant with a small addition concentration among a plurality of types of surfactants to the oil and stirring the first surfactant,
wherein the second step is performed when the addition and the stirring of the first surfactant with respect to the oil are completed,
wherein the second step includes adding a second surfactant having a greater addition concentration than the first surfactant among the plurality of types of surfactants to the oil and stirring the second surfactant.

13. A method for producing a dehumidifying composition, the method comprising:
adding 60 g of Tween 80 to each 400 g of silicone oil and stirring the Tween 80; and
additionally adding 120 g of Span 80 to each 400 g of the silicone oil, stirring the Span 80, and performing ultrasonic grinding on the Span 80 when the stirring of the Tween 80 in the silicone oil is completed.
